(19) United States
(12) Patent Application Publication
(10) Pub. No.: US 2024/0416888 A1
(43) Pub. Date: Dec. 19, 2024

(54) ELECTRIC BAKE CONTROL SYSTEM

(71) Applicant: FAIVELEY TRANSPORT RAIL TECHNOLOGIES INDIA PRIVATE LIMITED, Hosur (IN)

(72) Inventors: K KALAIMOHANA SELVAN, Hosur (IN); KRISHNAKUMAR SORNAMANI, Hosur (IN); GJ NATARAJ, Hosur (IN); MAURIZIO MITTINO, Hosur (IN); ROBERTO CORRENDO, Hosur (IN); BRUNO MAUGERI, Hosur (IN)

(73) Assignee: FAIVELEY TRANSPORT RAIL TECHNOLOGIES INDIA PRIVATE LIMITED, Hosur (IN)

(21) Appl. No.: 18/705,951

(22) PCT Filed: Oct. 28, 2022
(86) PCT No.: PCT/IN2022/050952

§ 371 Date: Apr. 29, 2024

(30) Foreign Application Priority Data
Oct. 29, 2021 (IN) 202141049698

(51) Int. Cl. B60T 17/22; B60T 13/66

(52) U.S. Cl. CPC B60T 17/228; B60T 13/665; B60T 2270/402; B60T 2270/414

(57) ABSTRACT

The invention relates to a brake control system (100) comprising a controller (102) receiving input indicating a directed change in a brake setting for a vehicle system (200), and brake units (108, 110, 114, 116, 118) onboard different ones of vehicles (204, 206) in the vehicle system. The brake units include electronic modules (108-1, 110-1, 114-1, 116-1, 118-1) and pneumatic modules (108-2, 110-2, 114-2, 116-2, 118-2). The pneumatic modules may be controlled by the electronic modules to control braking of the vehicles. The controller sends signals to the electronic modules based on the input and determines an inoperative state of a first electronic module of the brake units that is onboard a first vehicle of the vehicles and can direct a different, second electronic module of the brake units that is onboard the first vehicle or a second vehicle of the vehicles to control the brake unit of the first vehicle responsive to determining the inoperative state of the first electronic module.

### CROSS-REFERENCE TO RELATED APPLICATIONS

This application claims priority to Indian Patent Application No. 202141049698 (filed 29 Oct. 2021), the entire disclosure of which is incorporated herein by reference.

### BACKGROUND

### Technical Field

The present disclosure relates to the field of vehicle braking systems, such as braking systems for rail vehicles (e.g., locomotives).

### Discussion of Art

Vehicle transport of cargo and/or passengers is one of the leading areas that play an important role in accomplishing shortage eradication and sustainable developments. However, many transportation problems may be due to brake system failure, such as in railway brake system failures. Deceleration of a vehicle system can be a very complex process but of great importance for traffic safety, especially with rail vehicles. Vehicle systems may be equipped with braking systems that may use compressed air as a force to push blocks onto wheels or pads onto discs. These braking systems may be referred to as air brakes or pneumatic brakes and may be disposed onboard vehicles such as locomotives and/or coaches or wagons of a train. Compressed air can be transmitted along the vehicle system through a conduit, such as a brake pipe. Changing the level of air pressure in the pipe can cause a change in the state of the brake on each vehicle in the vehicle system. This can apply the brake, release the brake, or hold the brake on after a partial application. However, the response time of this braking system may be longer than desirable, and the release of the air pressure may not have regularity, potentially making the braking system unreliable and inefficient in ensuring effective braking.

Electronically controlled electro-pneumatic (ECP) brake systems are now implemented in some rail vehicle systems to overcome at least some of the deficiencies associated with air or pneumatic braking systems. The ECP brake systems may include electronic modules and pneumatic modules, where the electronic modules enable communication between driver brake controller and corresponding pneumatic modules, and the pneumatic modules enable application or release of the brakes.

In ECP braking, a pressurized air brake may be controlled by an electric brake and drain solenoid valves. When the brake is applied, an operator of the vehicle system may actuate an input device (e.g., a button or brake handle) until a reader or display shows an amount of brake cylinder pressure that the operator desires to be applied. When the input device is released or the brake handle is stopped at a required position, the brake controller may then send a signal to electronic modules of the vehicles in the vehicle system. This signal can enable or direct the pneumatic modules to supply compressed air to travel from a reservoir to the braking cylinders until the desired cylinder pressure is reached. This can change the level of air pressure in the brake pipe, thereby causing a change in the state of the brake on each vehicle.

Some existing ECP brake systems may overcome drawbacks associated with conventional air brake systems, however, failure of any of the electronic modules in some existing ECP brake systems may lead to failure of the pneumatic modules and the brake cylinders to work on time as required. This can lead to ineffective braking, and brake failure in the worst case, potentially leading to a fatal accident. Further, the ECP brake control system may not be compatible with all types of vehicles, such as UIC-type compliant mainline, freight, and passenger locomotives.

Therefore, there may be a need to overcome the above-mentioned drawbacks, shortcomings, and limitations associated with existing brake systems, and provide an efficient and reliable network-based, ECP brake control system for UIC-type compliant mainline, freight and passenger locomotives, as well as other rail vehicle systems and non-rail vehicle systems, which can handle failures in electronic modules to ensure effective braking in several failure situations.

### BRIEF DESCRIPTION

In one example, a brake control system may include a controller that can receive input indicating a directed change in a brake setting for one or more vehicles in a multi-vehicle system, and brake units disposed onboard different ones of the vehicles in the multi-vehicle system. The brake units may include electronic modules and pneumatic modules. The pneumatic modules may be controlled by the electronic modules to control braking of the vehicles. The controller may send electronic signals to the electronic modules of the brake units based on the input that is received by the controller. The controller can determine an inoperative state of a first electronic module of the brake units that is onboard a first vehicle of the vehicles and can direct a different, second electronic module of the brake units that is onboard the first vehicle or a second vehicle of the vehicles to control the brake unit of the first vehicle responsive to determining the inoperative state of the first electronic module.

### BRIEF DESCRIPTION OF THE DRAWINGS

The subject matter may be understood from reading the following description of non-limiting embodiments, with reference to the attached drawings, wherein below:

FIG. 1 illustrates a block diagram of one example of an electronic brake control system;

FIG. 2 illustrates one example of a vehicle system; and

FIG. 3 illustrates a flowchart of one example of a method for controlling a braking system of a vehicle system.

### DETAILED DESCRIPTION

Embodiments of the subject matter described herein relate to efficient and reliable network-based, ECP brake control systems that can handle failures in electronic modules through actuation or a shift in operation of other modules to ensure effective braking in several failure situations. The brake control system may ensure effective braking in vehicles (e.g., locomotives and corresponding coaches, or other non-rail vehicles, such as trucks, mining vehicles, agricultural vehicles, etc.) during failure situations of components of the associated ECP brake system on or in which the brake control system operates. The brake control system may be used to provide efficient and reliable braking for UIC type compliant mainline, freight, and passenger locomotives, as well as other vehicles. The brake control system may allow for efficient operation of the vehicles in lead mode (e.g., where the lead vehicle directs the throttle settings, brake settings, etc., of other vehicles), trail mode (e.g., where the trail vehicle(s) change their throttle settings, brake settings, etc., as directed by the lead vehicle), helper mode (e.g., a vehicle that temporarily joins with a vehicle system to help move the vehicle system, such as up a grade), and test mode (e.g., where the brakes are examined to see whether the brakes engage or not).

The brake control system may identify, reconfigure, and/or back-up key components in the event of failure. For example, if one pneumatic or electronic component in the braking system fails, another pneumatic or electronic component may step in and perform some or all the operations of the failed component. The brake control system may efficiently switch between and operate electronic modules of the ECP brake system to ensure effective braking in case of failure of some of the electronic modules, such as through actuation or a shift in working of other modules to ensure effective braking in several failure situations.

While one or more embodiments are described in connection with a rail vehicle system, not all embodiments are limited to rail vehicle systems. Unless expressly disclaimed or stated otherwise, the subject matter described herein extends to other types of vehicle systems, such as automobiles, trucks (with or without trailers), buses, marine vessels, aircraft, mining vehicles, agricultural vehicles, or other off-highway vehicles. The vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers) or logically coupled but not mechanically coupled. For example, vehicles may be logically but not mechanically coupled when the separate vehicles communicate with each other to coordinate movements of the vehicles with each other so that the vehicles travel together (e.g., as a convoy).

The electronic air (or electro-pneumatic) brake control system may include a set of brakes associated with one or more propulsion-generating vehicles (e.g., locomotives, trucks, etc.) and/or corresponding non-propulsion-generating vehicles (e.g., coaches, rail cars, etc.). The set of brakes may be operatively coupled to a brake cylinder (BC) and a main reservoir (MR) via a set of pipes.

The set of pipes may comprise brake pipes (BP) adapted to fluidically couple the vehicles in the vehicle system with each other (e.g., both propulsion-generating vehicles and non-propulsion-generating vehicles in the vehicle system or vehicle group). The brake pipes may be used to control each of the set of brakes in the vehicles (via pressure changes). The brake lines or pipes also can include or represent brake cylinder equalizing pipes (BCEQ) that fluidically couple the propulsion-generating vehicles, and that may independently control each of the brakes of these vehicles. Pneumatic pipes also may include main reservoir equalizing pipes (MREQ) that may fluidly couple the propulsion-generating vehicles to the main reservoir via hoses or other conduits. The MREQ also may control feeding of pressure between a lead propulsion-generating vehicle and one or more (or all) trail propulsion-generating vehicles among the propulsion-generating vehicles.

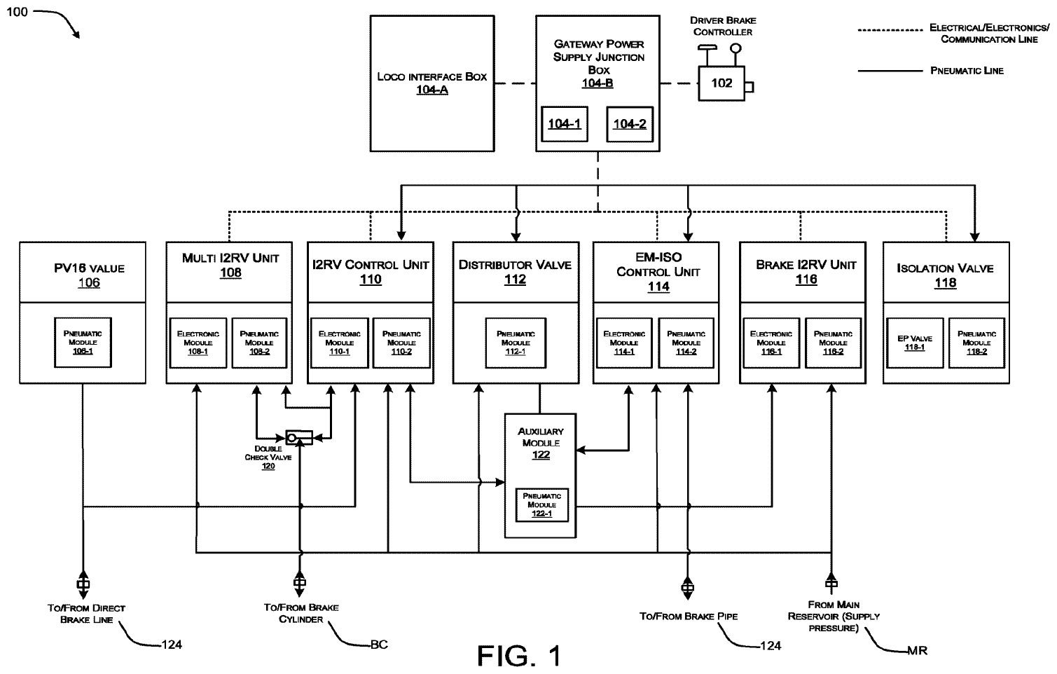

A driver brake controller (DBC) 102 may include a set of input devices (e.g., brake handles, buttons, switches, etc.) that may be in communication with one or more brake units (or brake devices) of the brake control system through a communication gateway 104B (“Gateway Power Supply Junction Box” in FIG. 1). The input devices (e.g., brake handles) may include an automatic brake handle to control and modulate pressure in the set of pipes and correspondingly control braking of the vehicles (propulsion-generating and non-propulsion-generating vehicles), and a set of independent brake handles to independently control braking of the propulsion-generating vehicles. The brake handles can include an automatic brake handle to control and modulate pressure in the set of pipes, and correspondingly control braking of all the propulsion-generating and non-propulsion-generating vehicles, and a set of independent brake handles to independently control braking of the propulsion-generating vehicles. The DBC can include a set of buttons, instead of or in addition to the brake handles. The buttons can also allow an operator to control and modulate pressure in the set of pipes, for automatic brake operation as well as independent brake operations.

The DBC can help operate the vehicles in a lead mode, helper mode, trail mode, and/or test mode. In lead mode, a propulsion-generating vehicle can be utilized to haul the non-propulsion-generating vehicle(s) alone or a leader consisting of multiple propulsion-generating vehicles. The helper mode can be used when multiple propulsion-generating vehicles are employed, where a trail propulsion-generating vehicle may be used to haul the vehicle system on a gradient. In the trail mode, multiple propulsion-generating vehicles can be commanded by another propulsion-generating vehicle. The test mode can be used to test the brake pipe by isolating the brake pipe from a brake pipe relay and carry out a self-test to check the health of the braking system.

The communication gateway can represent hardware circuitry that controls conduction of electronic signals from the controller and/or an interface box 104A (“Loco Interface Box” in FIG. 1, also referred to as an operator interface). The operator interface can represent an interface for other input devices onboard the same or another vehicle, such as a communication device, which can receive signals from the same or another vehicle to control the brakes of the vehicle system.

The signals received by the communication gateway from the operator interface and/or the controller may be conductively coupled via conductive pathways (e.g., wires, cables, buses, etc., which can be represented by broken lines in FIG. 1) to the units of the braking system. Additionally or alternatively, the signals may be wirelessly communicated using electromagnetic signals (e.g., radio, WIFI, cellular, ZIGBEE, BLUETOOTH, etc.). These units may include multi-intelligent integrated relay valve (multi I2RV) unit 108 (or multi-unit) that may operate to control braking in trail vehicles of a vehicle system (e.g., by generating signals that change pressure within braking cylinders of the trail vehicles), an I2RV control unit 110 that controls the pressure in a brake cylinder of the lead vehicle of the vehicle system, a brake I2RV unit 116 (also referred to as a brake pipe charging unit) that controls charging of a brake line or pipe 124 in the vehicle system to send pneumatic signals to engage or release a brake of a vehicle, an isolation valve 118 that can isolate (e.g., cut off or separate) the brake I2RV unit from the brake pipe of a vehicle (e.g., during an emergency brake application), and an emergency isolation (EM-ISO) unit 114 that controls pressure in the brake pipe for the emergency brake application.

For example, each unit may include an electronic module (e.g., modules 106-1, 110-1, 114-1, 116-1, and 118-1) representing hardware circuitry that may include and/or be connected with one or more processors (e.g., microprocessors, field programmable gate arrays, drivers, integrated circuits, etc.) that receive electronic signals from the controller 102 or interface 104A via the gateway 104B. These units can then act on these signals, such as by controlling a corresponding pneumatic modules (e.g., modules 106-2, 110-2, 114-2, 116-2, and 118-2) that may represent one or more valves, solenoids, or the like, to control the flow of a fluid (e.g., air) in a brake pipe, brake cylinder, reservoir, or the like.

The electronic module associated with the corresponding one or more units may comprise one or more electronically controlled pneumatic valves for charging, holding, and venting pressure between the units, and one or more transducers or other sensors to monitor the associated pressure. Further, the pneumatic module associated with the corresponding unit may comprise any or a combination of a relay valve, double check valve, and 3/2 valve to achieve a predefined output pressure and to reroute the signal pressures.

The electronic module of the multi-I2RV unit (or multi-unit) may receive an electronic signal or communication (such as CAN, etc.) from the interface and/or controller via the gateway and may control the pneumatic module of the same unit to engage or release the brake(s) of the trail vehicle in which the multi-I2RV unit is disposed or that is controlled by the multi-I2RV unit. The electronic module of the I2RV control unit may receive an electronic signal or communication (such as CAN, etc.) from the interface and/or controller via the gateway and may control the pneumatic module of the same unit to change the pressure in the brake cylinder (to engage or release the brake(s)) of the lead vehicle in which the I2RV control unit is disposed or that is controlled by the I2RV control unit. The electronic module of the EM-ISO control unit may receive an electronic signal or communication (such as CAN, etc.) from the interface and/or controller via the gateway and may control the pneumatic module of the same unit to change the pressure in the brake pipe for an emergency brake application. The electronic module of the brake I2RV unit may receive an electronic signal or communication (such as CAN, etc.) from the interface and/or controller via the gateway and may control the pneumatic module of the same unit to change the pressure in the brake pipe to apply or release the brake(s) of the trailing vehicle whose brakes are controlled by a similar unit (e.g., different vehicles may have different units to control the brakes in the respective vehicles). The electronic module of the isolation valve or isolation valve unit may receive an electronic signal from the interface and/or controller via the gateway and may control the pneumatic module of the same unit to isolate the brake I2RV unit (of the same vehicle) from the brake pipe to isolate that brake I2RV unit from the brake pipe. For example, this pneumatic module of the isolation valve may close a valve to seal off the pneumatic module of the brake I2RV unit from the brake pipe. This can occur during or responsive to an emergency brake application of the vehicle system (in which all or several brakes are engaged at the same time) or when the brake system is configured to operate in or onboard a trail or helper vehicle.

An auxiliary module 122 may be or may include another pneumatic module 122-1 that operates as a pneumatic coupling or interface between pneumatic modules of other units, such as the I2RV control unit, the EM-ISO unit, the brake I2RV units, etc. The auxiliary module may receive pneumatic signals (e.g., changes in pressure propagated along) from one unit and may control one or more valves represented by the pneumatic module of the auxiliary module to forward, direct, or continue the propagation of the pneumatic signal to the pneumatic module of another unit.

The health or operative states of the electronic modules may be repeatedly examined by evaluating changes or differences in pressures of the fluid (e.g., air) in one or more locations of the brake system. For example, an electronic module may receive a signal from the interface or controller commanding or directing the electronic module to create a command signal directing the pneumatic module to generate a pneumatic signal having a target or designated pressure. The electronic module (or transducers of the module) can measure the pressure that is commanded, the target pressure, and can measure the output pressure from the pneumatic module. These pressures can be compared (e.g., by the electronic module, the controller, the interface, etc.). If there is a deviation between the pressures (e.g., a difference that exceeds a threshold), then a fault or failure of the electronic module may be identified.

Optionally, the electronic modules of the units may communicate with each other, with the interface, and/or with the controller to examine the health of the electronic modules and/or units. For example, the controller, interface, and/or gateway may send an electronic signal via one or more conductive pathways in the control system and/or wirelessly to an electronic module. The electronic module may receive this signal and send a responsive electronic signal or communication (such as CAN, etc.) back to the controller, interface, and/or gateway via the same or different conductive pathways and/or wirelessly to confirm receipt of the prior signal. As another example, the electronic module may send an electronic signal or communication (such as CAN, etc.) via one or more conductive pathways in the control system and/or wirelessly to the controller, interface, and/or gateway. The controller, interface, and/or gateway may receive this signal and send a responsive electronic signal back or communication (such as CAN, etc.) to the electronic module via the same or different conductive pathways and/or wirelessly to confirm receipt of the prior signal.

The successful exchange of electronic signals or communication (such as CAN, etc.) may establish a handshake between the electronic module and the controller, interface, and/or gateway. This may indicate that the electronic module is operational, is in a healthy state, in an operational state, etc. Conversely, if the interface, gateway, or controller does not receive an electronic signal from the electronic module, this may indicate an unsuccessful exchange of electronic signals and may not establish the handshake between the electronic module and the controller, interface, and/or gateway. This may indicate that the electronic module is not operational, is not in a healthy state, is in an inoperative state, etc. The controller can evaluate the health or operational states of the electronic modules using this exchange or handshake.

The electronic modules of the units may communicate with each other, with the interface, and/or with the controller to examine the health of the pneumatic modules of the units. For example, the controller, interface, and/or gateway may send an electronic signal via one or more conductive pathways in the control system and/or wirelessly to an electronic module. The electronic module may receive this signal and attempt to change a state of the corresponding pneumatic unit, such as by changing a state or position of a valve. If the state of the pneumatic unit is successfully changed, then the electronic module may send a responsive electronic signal back to the controller, interface, and/or gateway via the same or different conductive pathways and/or wirelessly to confirm that the pneumatic module is operating. If the state of the pneumatic unit is not successfully changed, then the electronic module may send a responsive electronic signal back to the controller, interface, and/or gateway via the same or different conductive pathways and/or wirelessly to indicate that the pneumatic module is not operating.

Based on input (e.g., a position of the set of brake handles set by an operator, input from another system such as a control system or energy management system, etc.), the health or operative state of the electronic module(s) of one or more units, and/or the health or operative state of the pneumatic module(s) of the one or more units, the gateway may enable switching between the units and transmit a set of control signals to at least one of the one or more units to control and operate braking of the one or more vehicles in one or more modes.

In an aspect, when the brake I2RV unit of a lead vehicle fails (e.g., the pneumatic module of the unit fails) during a lead mode of operation, the gateway may direct the electronic module of the I2RV control unit of the same lead vehicle to control the pneumatic module of that unit generate a pneumatic signal pressure, which may be fed to the brake I2RV valve unit through the auxiliary module. The pneumatic module of the brake I2RV valve unit may correspondingly control the brake pipe pressure. This can allow for one unit having an inoperative module to control the pneumatic module of another unit (via the auxiliary module) and continue control of the vehicle braking system.

As another example, the electronic module of the multi-I2RV unit may generate a pressure signal (e.g., for controlling the brake cylinder) based on the brake pipe pressure, which may be fed to a pneumatic module of the multi-I2RV unit for controlling the pressure in the brake cylinder via a double check valve 120 between the pneumatic modules of the multi-I2RV unit and the I2RV control unit. This can allow for the multi-I2RV unit to control the brake cylinder of the lead vehicle via the double check valve in the event of failure or an inability to communicate with the I2RV control unit.

If the I2RV control unit fails during a lead mode, trail mode, or helper mode of the vehicle in which the I2RV control unit is disposed or located, the gateway may replace the functions provided by that I2RV control unit with the multi-I2RV unit. The multi-I2RV unit may control the operation of the set of brakes. The electronic module of the multi-I2RV unit may generate the BC signal pressure based on brake pipe pressure, which is fed to the pneumatic module of the multi-I2RV unit for controlling the BC via the double check valve.

If the multi-I2RV unit fails, the output of the I2RV control unit may be fed as signal pressure to the multi-I2RV unit via the double check valve, and the pneumatic module of the multi-I2RV unit may correspondingly generate and supply required pressure in the BCEQ.

The control system may include a first power supply 104-1 that may electrically or conductively couple the I2RV control unit and the EM-ISO unit to the gateway, and a second power supply 104-2 that may electrically couple the brake I2RV unit and the multi-I2RV unit to the gateway. These power supplies may or may not be conductively coupled with each other, or only a single power supply may be coupled with these units. While two power supplies are shown, optionally more than two power supplies may be provided. The power supplies can represent batteries, fuel cells, alternators, generators, flywheels, etc.

The control system may adjust which units operate to control changes in pneumatic pressures in the braking system responsive to failure of one or more of the power supplies.

If the first power supply fails (e.g., during auto brake operation of the braking system), the gateway may replace the I2RV control unit with a distributor valve (DV) 112 that is pneumatically or fluidly coupled with the I2RV control valve, the EM-ISO control unit, the isolation valve, and the auxiliary module, as shown in FIG. 1. The distributor valve may sense pressure variations in the brake pipe and may accordingly control or communicate the pressure signal for controlling the brake cylinder to the pneumatic module of the I2RV control unit through the auxiliary module (e.g., to control braking in the vehicle). Based on the signal pressure that is received, the pneumatic module of the I2RV control unit may correspondingly control the BC pressure to control braking.

If the first power supply fails during independent brake operation, the gateway may replace the I2RV control unit with the multi-I2RV unit. The multi-I2RV unit may control charging and venting of the BCEQ and may also control the BC signal pressure based on the brake pipe pressure for controlling the BC pressure via the double check valve. Further, the brake I2RV unit and the isolation valve unit may continue to perform generation of (e.g., increase) or drop (e.g., decrease) the brake pipe pressure.

If the second power supply fails during independent brake operation, the electronic module of the I2RV control unit may control the generation of a brake pipe signal pressure, which may be fed to the brake I2RV unit through the auxiliary module. Based on the received signal pressure, the pneumatic module of the brake I2RV unit may correspondingly control the BC pressure to control braking of that vehicle (having the BC).

If the second power supply fails during an auto braking operation (e.g., braking of all or many of the vehicles via a pressure change in the brake pipe or line), the gateway may replace operation of the I2RV control unit with the distributor valve. The distributor valve may sense brake pipe pressure variations and may accordingly control the brake cylinder signal pressure to the pneumatic module of the I2RV control unit through the auxiliary module. Based on the received signal pressure, the pneumatic module of the I2RV control unit may correspondingly control the BC pressure (to control braking of the vehicle having the brake cylinder).

For service brake during normal auto brake operation driven by the automatic brake handle, the brake I2RV unit and the isolation valve unit may generate or drop the pressure in the brake pipes to actuate and de-actuate the corresponding brakes respectively. The I2RV control unit may monitor the status of the brake pipes (e.g., the pressure of air in the brake pipes) and may correspondingly control and adjust the pressure in the BC to a predefined value.

For bail-off during normal auto brake operation driven by the independent brake handle the gateway may transmit a set of bail-off signals to the I2RV control unit. This unit may correspondingly reduce the pressure in the applied set of brakes (e.g., to zero or very little pressure) in a vehicle (e.g., a propulsion-generating vehicle) without changing the pressure in the brake pipes.

For emergency braking during auto brake operation, the EM-ISO unit may actuate and de-actuate emergency valves associated with emergency brakes to vent pressure of the brake pipes at a predefined rate. Further, the EM-ISO unit may cut charging of the brake pipe during the emergency braking.

For independent braking during a normal condition or operational state driven by the independent brake handle, the gateway may enable or control the I2RV control unit to convert the MR pressure directly into the BC pressure. The multi-I2RV unit may convert the MR pressure into the BCEQ pressure, which is fed to the trail vehicles in the vehicle system.

The control system can implement CAN communications protocol, but not limited to the like, for establishing communication between one or more units and the DBC and gateway. The gateway can provide the electric and logic interface with the propulsion-generating vehicle(s) and can also help manage internal communications and functionalities in the control system. The control system can include power supplies, where a first power supply can connect the I2RV control unit and EM-ISO unit to the gateway, and a second power supply can connect the brake I2RV unit and multi-I2RV unit to the gateway, as described above.

The units can include an electronic module including electro-pneumatic (EP) valves and transducers. The EP valves can be used for charging, holding & venting signal pressure and to reroute signal pressure from one unit to another. Transducers can be used to monitor the pressure, to check whether the target pressure is achieved, and thus form a closed-loop control. The pneumatic modules can include relay valves, double check valves, 3/2 valves, etc. to achieve the required output pressure and to reroute the signal pressures

Upon generation of an automatic brake request when the operator may move the automatic brake handle to a service zone position while operating in a lead mode, the DBC can transmit a CAN signal to or with the gateway, which accordingly can pass control signals onto the units. The brake I2RV unit and the isolation valve unit can accordingly generate or drop the pressure in the brake pipes to actuate and de-actuate the corresponding brakes, respectively. The I2RV control unit can monitor the status of the brake pipes and can correspondingly control and adjust the pressure in the BC to a predefined value.

Upon generation of a bail-off command during automatic brake operation when the operator may move the independent brake handle to the bail-off position, the DBC can transit CAN signals to the gateway, which correspondingly transmits a set of bail-off signals to the I2RV control unit. The I2RV control unit can then reduce the pressure in the applied set of brakes (e.g., to zero pressure or another pressure), without changing the pressure in the brake pipes. The bail-off command can be used to release the vehicle brakes (e.g., by venting the pressure in the BC) applied through automatic brakes, without changing the brake pipe pressure level. To develop pressure in the BC again (e.g., to increase this pressure), the automatic brake handle of DBC may be moved for further brake application. It may not be possible, however, to bail off the BC pressure in an emergency condition.

For emergency braking during auto brake operation, the EM-ISO unit can actuate and de-actuate emergency valves associated with emergency brakes to vent pressure of the brake pipes at an emergency rate, so that charging of the brake pipe can be cut or otherwise stopped.

For independent braking during the normal condition, the operator can move the set of independent brake handles accordingly. Based on the position of the independent brake handle, the DBC can transmit a CAN signal to the gateway, which may enable the I2RV control unit to convert the MR pressure directly into the BC pressure. Further, the multi-I2RV unit can convert the MR pressure into the BCEQ pressure, which can be fed to the trail vehicles.

In case of a failure of the electronics module of the brake I2RV unit during the lead mode of operation, the brake pipe functionality or control can be taken care of or controlled by the I2RV control unit, and BC pressure functionality or control can be taken care of or controlled by the multi-I2RV unit. During this condition, the electronics module in the I2RV control unit can take charge of or control brake pipe signal pressure generation. The brake pipe signal pressure can be generated in the I2RV control unit, which can be fed to the brake I2RV unit through the auxiliary module via the pneumatic module of the auxiliary module. Upon receiving the signal pressure from the electronic module of the I2RV control unit, the pneumatic module in the brake I2RV unit can generate or deplete the brake pipe pressure accordingly. Further, during this condition, the electronic module of the multi-I2RV unit can generate the BC signal pressure based on the brake pipe pressure, which can be fed to the pneumatic module of the multi-I2RV unit for controlling the BC pressure via the double check valve. Measurement of pressure in the brake pipe can be carried out using transducers in the electronic module of the I2RV control unit and/or the EM-ISO unit.

In case of failure of the I2RV control unit during the lead mode of operation, the function of the I2RV control unit can be taken over by the multi-I2RV unit, and the electronic module of the multi-I2RV unit can generate or deplete the signal pressure in the brake cylinder according to the brake pipe pressure, and can supply the signal pressure to the pneumatic module of multi-I2RV unit. During this condition or state, the gateway can replace operation of the I2RV control unit with the multi-I2RV unit, and the multi-I2RV unit can control operation of the set of brakes. The electronic module of the multi-I2RV unit can generate the BC signal pressure based on the brake pipe pressure, which can be fed to the pneumatic module of the multi-I2RV unit for controlling the pressure in the BC via the double check valve. The brake pipe pressure measurement can be carried out using transducers in the electronic modules of the I2RV control unit and/or the EM-ISO unit.

In event of failure of the multi-I2RV unit during the lead mode of the vehicle system, the output of the I2RV control unit can be fed as signal pressure to the multi-I2RV unit, and the pneumatic module of the multi-I2RV unit can correspondingly generate and supply required output pressure in the BCEQ line.

Responsive to the first power supply failing during auto brake operation in lead mode, the gateway can replace operation or functionality of the I2RV control unit with the DV, where the DV can sense brake pipe pressure variations and can accordingly control the BC signal pressure to the pneumatic module of the I2RV control unit through the auxiliary module. Further, based on the received signal pressure, the pneumatic module of the I2RV control unit can correspondingly control the BC pressure. In another embodiment, responsive to the first power supply failing during independent brake operation in the lead mode, the gateway can replace functionality of the I2RV control unit with the multi-I2RV unit, where the pneumatic module of the multi-I2RV unit can control charging and venting of BCEQ, and can also control the BC signal pressure based on brake pipe pressure for controlling the BC pressure via the double check valve. The brake I2RV unit and the isolation valve unit can continue to perform generation (e.g., increases) or drop (e.g., decreases) in the brake pipe pressure as the normal running condition.

Responsive to the second power supply failing while operating in a lead mode, the electronic module of the I2RV control unit can control generation of brake pipe signal pressures, which can be fed to the brake I2RV unit through the auxiliary module. Further, based on the received signal pressure, the pneumatic module of the brake I2RV unit can correspondingly control the BP pressure. In another example, responsive to the second power supply failure during auto braking operation, the gateway can replace the I2RV control unit with the DV, where the DV can sense brake pipe pressure variations and can accordingly control the BC signal pressure to the pneumatic module of the I2RV control unit through the auxiliary module. Based on the received signal pressure, the pneumatic module of the I2RV control unit can correspondingly control the BC pressure.

During a normal working condition of the propulsion-generating vehicle operating in the trail mode, only the I2RV control unit may be kept active, and other units can be kept in an idle condition. The electronics module in the I2RV control unit can sense charging and/or depletion in brake pipe pressure and can accordingly vent and/or charge BC pressure in the trail propulsion-generating vehicle. As the generation/depletion of brake pipe pressure is controlled by the brake I2RV unit of the lead propulsion-generating vehicle, the brake I2RV unit in the trail vehicle can remain in the idle condition or state.

In case of failure of the I2RV control unit during operation in the trail mode, the gateway can replace the functionality provided by the I2RV control unit with the multi-I2RV unit, and the multi-I2RV unit can control operation of the brakes. During this condition, the electronic module of the multi-I2RV unit can generate the BC signal pressure based on the brake pipe pressure, which can be fed to the pneumatic module of the multi-I2RV unit for controlling the BC via the double check valve.

In case of failure of the first power supply during operation in the trail mode, the gateway can replace the functionality provided by the I2RV control unit with the functionality performed by the multi-I2RV unit, and the multi-I2RV unit can control operation of the set of brakes. During this condition, the electronic module of the multi-I2RV unit can generate the BC signal pressure based on the brake pipe pressure, which can be fed to the pneumatic module of the multi-I2RV unit for controlling the BC (to engage or release the brake(s)) via the double check valve.

During the normal working condition of the propulsion-generating vehicles operating in the helper mode, only the I2RV control unit and the multi-I2RV unit can be kept active by the gateway, with other units or all other units kept in an idle condition or state. During this condition, the electronic module in the I2RV control unit can sense charging or depletion of pressure in the brake pipe and can accordingly vent or charge the pressure in the brake cylinder in the helper vehicle to engage or release brakes, as appropriate. Further, the electronic modules of the I2RV control unit and the multi-I2RV unit can sense the independent brake handle position or input and can accordingly charge or deplete the BC and the BCEQ pressures in the helper propulsion-generating vehicles and/or other propulsion-generating vehicles.

In event of failure of the I2RV control unit during operation in the helper mode, the gateway can replace the functionality previously provided by the I2RV control unit with functionality provided by the multi-I2RV unit, and the multi-I2RV unit can control the operation of the set of brakes. During this condition, the electronic module of the multi-I2RV unit can generate the BC signal pressure based on brake pipe pressure, which can be fed to the pneumatic module of the multi-I2RV unit for controlling the BC via the double check valve.

In case of failure of the first power supply during operation in the helper mode, the gateway can replace functionality provided by the I2RV control unit with functionality provided by the multi-I2RV unit. For example, the multi-I2RV unit can control operation of the set of brakes that previously were controlled by the I2RV control unit (prior to failure of the first power supply). During this condition, the electronic module of the multi-I2RV unit can generate the BC pressure signal based on the brake pipe pressure, which can be fed to the pneumatic module of the multi-I2RV unit for controlling the BC via the double check valve.

As emergency functionalities are taken care of by EM-ISO unit 114 in lead mode, thus, failure of EM-ISO unit 114 in trail mode or helper mode can not cause any impact on the working of the system 100.

One or more embodiments described herein relate to communication (e.g., propagation) of pneumatic signals as changes in pressure propagating through, along, or within a conduit such as a brake line or brake pipe. These signals may be referred to as pressure signals and can be implemented as changes in pressure in the fluid (e.g., air) in the brake pipe that moves along the length of the brake pipe. While the pressure signals may be communicated or conveyed through or via the double check valve, optionally the double check valve may be replaced by another valve (e.g., a single check valve, a valve that is not a check valve, etc.) or a section of a conduit such as the brake pipe that does not include a valve.

The systems and methods described herein enable monitoring the health of electronic modules and key components of the brake control system, and accordingly switching between and operating electronic modules of the brake control system to ensure effective braking in vehicles in the event of failure of some of the electronic modules. This may allow the control system to operate with the unique ability to operate in various modes, and identify, reconfigure, and back up key components in the event of failure, and also makes the system reliable and compliant to various types of vehicles, such as UIC type mainline, freight, and passenger locomotives.

The systems and methods provide an efficient and reliable network-based, electro-pneumatic brake control system for vehicles, which can handle failures in electronic modules through actuation or a shift in working of other modules to ensure effective braking in several failure situations.

The control system and method can ensure effective braking in vehicles in failure situations of the components of the associated ECP brake system. The brake control system may allow for efficient operation of the vehicles in lead mode, trail mode, helper mode, test mode, or the like. The control system may have an ability to identify, reconfigure, and back-up key components in the event of failure by efficiently switching between and operating electronic modules of the brake control system to ensure effective braking in case of failure of one or more of the electronic modules.

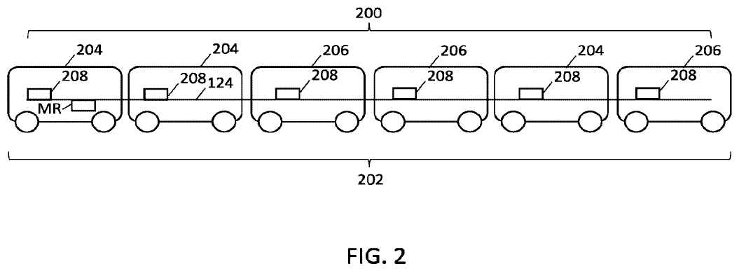

FIG. 2 illustrates one example of a braking system 200 that is controlled by the control system shown in FIG. 1. The braking system and components of the control system can be disposed onboard a vehicle system 202 formed from several vehicles 204, 206. These vehicles can represent the propulsion-generating vehicles 204 and the non-propulsion-generating vehicles 206 described herein. The vehicles may have the brake line or brake pipe extending through the vehicles and along the length of the vehicle system. This brake line or pipe is connected with braking devices 208 onboard the vehicles, which can represent brakes, brake cylinders, reservoirs, etc. that are used to engage or release the brakes of the braking system.

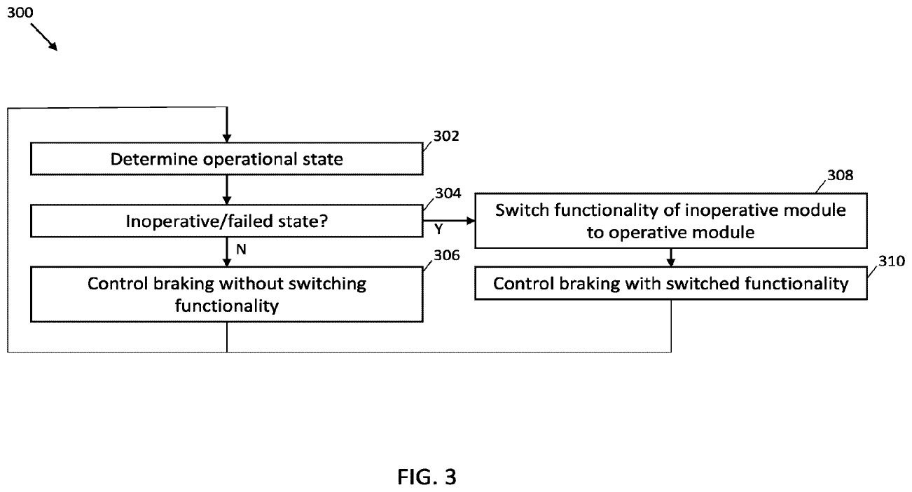

FIG. 3 illustrates a flowchart of one example of a method 300 for controlling a braking system of a vehicle system. The method can represent operation of the control system shown in FIG. 1 and described herein. At step 302, an operational state of one or more electronic modules of the units of the braking system is determined. This can involve determining whether the electronic modules are able to reply to an electronic signal sent to the modules via conductive pathways or wireless signals. If the module is or modules are unable to reply or do not reply, then that module or those modules may be identified as being in a failed or inoperative state. At decision point 304, a decision is made as to whether the one or more of these electronic modules is in an inoperative or failed state. If the electronic modules are in operative states, then the braking function provided by those electronic modules may continue to be controlled by those modules. As a result, flow of the method can proceed toward step 306 where braking is controlled by the electronic modules in a normal or operative state and without switching the functionality provided by different electronic modules. Flow of the method can then return toward step 302 or may terminate.

But, if an electronic module is in an inoperative or failed state, then the braking function provided by (e.g., controlled by) that electronic module may need to be performed by another electronic module to ensure safe and reliable braking of the vehicle system. As a result, flow of the method can proceed toward step 308. At step 308, the functionality provided by the failed or inoperable electronic module is swapped out, replaced by, or switched to another electronic module, as described herein. At step 310, braking is controlled using the functionality that was switched from the inoperative electronic module to another electronic module, as described herein. Flow of the method may then return toward step 302 or may terminate.

In one embodiment, the control system may have a local data collection system deployed that may use machine learning to enable derivation-based learning outcomes. The controller may learn from and make decisions on a set of data, by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, the control system may include a policy engine that may apply one or more policies. These policies may be based at least in part on characteristics of a given item of equipment or environment. With respect to control policies, a neural network can receive input of a number of environmental and task-related parameters. These parameters may include an identification of an inoperative electronic module. The neural network can be trained to generate an output based on these inputs, with the output representing another electronic module to replace the functionality of the inoperative module. During operation of one embodiment, a determination can occur by processing the inputs through the parameters of the neural network to generate a value at the output node designating that action as the desired action. This action may translate into a signal that causes the vehicle to operate (e.g., brake). This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network is generated and then different adjustments to the parameters are made, and simulations are done. Once the output from the various models is obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

In one example, a brake control system may include a controller that can receive input indicating a directed change in a brake setting for one or more vehicles in a multi-vehicle system, and brake units disposed onboard different ones of the vehicles in the multi-vehicle system. The brake units may include electronic modules and pneumatic modules. The pneumatic modules may be controlled by the electronic modules to control braking of the vehicles. The controller may send electronic signals to the electronic modules of the brake units based on the input that is received by the controller. The controller can determine an inoperative state of a first electronic module of the brake units that is onboard a first vehicle of the vehicles and can direct a different, second electronic module of the brake units that is onboard the first vehicle or a second vehicle of the vehicles to control the brake unit of the first vehicle responsive to determining the inoperative state of the first electronic module.

The controller may determine the inoperative state of the first electronic module by identifying a difference in a commanded pressure that the first electronic module directs a first pneumatic module of the pneumatic modules to implement, and a measured pressure brought about by the first pneumatic module. The brake units may include a control unit that can control a pressure in a brake pipe within a lead vehicle of the vehicles and a charging brake unit that can charge the pressure in the brake pipe in several of the vehicles. The controller may direct the electronic module of the control unit to generate a pressure signal for the charging brake unit via an auxiliary module to change the pressure in the brake pipe responsive to determining that the charging brake unit is in the inoperative state.

The brake units may include a control unit that can control a pressure in a brake pipe within a lead vehicle of the vehicles and a multi-unit that can control a pressure in the brake pipe within a trail vehicle of the vehicles. The controller may direct the electronic module of the multi-unit to generate a pressure signal for the control unit via an auxiliary module to change the pressure in the brake pipe responsive to determining that the control unit is in the inoperative state. The brake units may include a control unit that can control a pressure in a brake cylinder equalizing pipe within a lead vehicle of the vehicles and a multi-unit that can control a pressure in the brake pipe within a trail vehicle of the vehicles. The controller may direct the electronic module of the control unit to generate a pressure signal for the multi-unit to change the pressure in the brake cylinder equalizing pipe responsive to determining that the multi-unit is in the inoperative state.

The brake units may include a control unit that can control a pressure in a brake cylinder equalizing pipe within a lead vehicle of the vehicles and an isolation unit that can control the pressure in the brake pipe for an emergency brake application. The controller may send the electronic signals to the electronic modules via a communication gateway that includes a first power supply configured to connect and supply power to the electronic modules of the control unit and the isolation unit. The controller can direct a distributor valve configured to isolate the multi-unit from the brake pipe to generate the pressure signal to the control unit responsive to failure of the first power supply. The controller may direct the electronic module of the multi-unit to control charging and/or venting the brake cylinder equalizing pipe in place of the control unit responsive to failure of the first power supply.

The brake units may include a valve unit configured to control a pressure in a brake cylinder equalizing pipe within a lead vehicle of the vehicles and a multi-unit that can control a pressure in the brake pipe within a trail vehicle of the vehicles. The controller may send the electronic signals to the electronic modules via the communication gateway that includes a second power supply that can connect and supply power to the electronic modules of the valve unit and the multi-unit. The controller can direct the electronic module of the control unit to increase pressure in the brake pipe instead of the charging unit responsive to failure of the second power supply. The controller may direct the distributor valve to change the pressure in the brake cylinder instead of the control unit responsive to failure of the second power supply.

The electronic modules may include one or more electro-pneumatic valves for controlling pressure between the brake units and one or more transducers to monitor the pressure. The pneumatic modules may include one or more of a relay valve, a double check valve, or a 3/2 valve. The vehicles may be rail vehicles. The brake units may be disposed on different ones of the vehicles.

Use of phrases such as “one or more of . . . and,” “one or more of . . . or,” “at least one of . . . and,” and “at least one of . . . or” are meant to encompass including only a single one of the items used in connection with the phrase, at least one of each one of the items used in connection with the phrase, or multiple ones of any or each of the items used in connection with the phrase. For example, “one or more of A, B, and C,” “one or more of A, B, or C,” “at least one of A, B, and C,” and “at least one of A, B, or C” each can mean (1) at least one A, (2) at least one B, (3) at least one C, (4) at least one A and at least one B, (5) at least one A, at least one B, and at least one C, (6) at least one B and at least one C, or (7) at least one A and at least one C.

As used herein, an element or step recited in the singular and preceded with the word “a” or “an” do not exclude the plural of said elements or operations, unless such exclusion is explicitly stated. Furthermore, references to “one embodiment” of the invention do not exclude the existence of additional embodiments that incorporate the recited features. Moreover, unless explicitly stated to the contrary, embodiments “comprising,” “comprises,” “including,” “includes,” “having,” or “has” an element or a plurality of elements having a particular property may include additional such elements not having that property. In the appended claims, the terms “including” and “in which” are used as the plain-English equivalents of the respective terms “comprising” and “wherein.” Moreover, in the following claims, the terms “first,” “second,” and “third,” etc. are used merely as labels, and do not impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function devoid of further structure.

The above description is illustrative, and not restrictive. For example, the above-described embodiments (and/or aspects thereof) may be used in combination with each other. In addition, many modifications may be made to adapt a particular situation or material to the teachings of the subject matter without departing from its scope. While the dimensions and types of materials described herein define the parameters of the subject matter, they are exemplary embodiments. The scope of the subject matter should, therefore, be determined with reference to the appended claims, along with the full scope of equivalents to which such claims are entitled.

This written description uses examples to disclose several embodiments of the subject matter, including the best mode, and to enable one of ordinary skill in the art to practice the embodiments of subject matter, including making and using any devices or systems and performing any incorporated methods. The patentable scope of the subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

1. A brake control system comprising:
a controller configured to receive input indicating a directed change in a brake setting for one or more vehicles in a multi-vehicle system; and
brake units disposed onboard different ones of the vehicles in the multi-vehicle system, the brake units including electronic modules and pneumatic modules, the pneumatic modules configured to be controlled by the electronic modules to control braking of the vehicles,
the controller configured to send electronic signals to the electronic modules of the brake units based on the input that is received by the controller, the controller configured to determine an inoperative state of a first electronic module of the brake units that is onboard a first vehicle of the vehicles and to direct a different, second electronic module of the brake units that is onboard the first vehicle or a second vehicle of the vehicles to control the brake unit of the first vehicle responsive to determining the inoperative state of the first electronic module.

2. The brake control system of claim 1, wherein the controller is configured to determine the inoperative state of the first electronic module by identifying a difference in a commanded pressure that the first electronic module directs a first pneumatic module of the pneumatic modules to implement, and a measured pressure brought about by the first pneumatic module.

3. The brake control system of claim 1, wherein the brake units include a control unit configured to control a pressure in a brake pipe within a lead vehicle of the vehicles and a charging brake unit configured to charge the pressure in the brake pipe in several of the vehicles,
wherein the controller is configured to direct the electronic module of the control unit to generate a pressure signal for the charging brake unit via an auxiliary module to change the pressure in the brake pipe responsive to determining that the charging brake unit is in the inoperative state.

4. The brake control system of claim 1, wherein the brake units include a control unit configured to control a pressure in a brake pipe within a lead vehicle of the vehicles and a multi-unit configured to control a pressure in the brake pipe within a trail vehicle of the vehicles,
the controller configured to direct the electronic module of the multi-unit to generate a pressure signal for the control unit via an auxiliary module to change the pressure in the brake pipe responsive to determining that the control unit is in the inoperative state.

5. The brake control system of claim 1, wherein the brake units include a control unit configured to control a pressure in a brake cylinder equalizing pipe within a lead vehicle of the vehicles and a multi-unit configured to control a pressure in the brake pipe within a trail vehicle of the vehicles,
the controller configured to direct the electronic module of the control unit to generate a pressure signal for the multi-unit to change the pressure in the brake cylinder equalizing pipe responsive to determining that the multi-unit is in the inoperative state.

6. The brake control system of claim 1, wherein the brake units include a control unit configured to control a pressure in a brake cylinder equalizing pipe within a lead vehicle of the vehicles and an isolation unit configured to control the pressure in the brake pipe for an emergency brake application,
the controller is configured to send the electronic signals to the electronic modules via a communication gateway that includes a first power supply configured to connect and supply power to the electronic modules of the control unit and the isolation unit.

7. The brake control system of claim 6, wherein the brake units include a multi-unit configured to control a pressure in the brake pipe within a trail vehicle of the vehicles, wherein the controller is configured to direct a distributor valve configured to isolate the multi-unit from the brake pipe to generate the pressure signal to the control unit responsive to failure of the first power supply.

8. The brake control system of claim 6, wherein the brake units include a multi-unit configured to control a pressure in the brake pipe within a trail vehicle of the vehicles, wherein the controller is configured to direct the electronic module of the multi-unit to control one or more of charging or venting the brake cylinder equalizing pipe in place of the control unit responsive to failure of the first power supply.

9. The brake control system of claim 6, wherein the brake units include a valve unit configured to control a pressure in a brake cylinder equalizing pipe within a lead vehicle of the vehicles and a multi-unit configured to control a pressure in the brake pipe within a trail vehicle of the vehicles,
the controller is configured to send the electronic signals to the electronic modules via the communication gateway that includes a second power supply configured to connect and supply power to the electronic modules of the valve unit and the multi-unit.

10. The brake control system of claim 9, wherein the controller is configured to direct the electronic module of the control unit to increase pressure in the brake pipe instead of the charging unit responsive to failure of the second power supply.

11. The brake control system of claim 9, wherein the controller is configured to direct a distributor valve to change the pressure in the brake cylinder instead of the control unit responsive to failure of the second power supply.

12. The brake control system of claim 1, wherein the electronic modules include one or more electro-pneumatic valves for controlling pressure between the brake units and one or more transducers to monitor the pressure.

13. The brake control system of claim 1, wherein the pneumatic modules include one or more of a relay valve, a double check valve, or a 3/2 valve.

14. The brake control system of claim 1, wherein the vehicles are rail vehicles.

15. The brake control system of claim 1, wherein the brake units are disposed on different ones of the vehicles.
